(19) United States
(12) Patent Application Publication
(10) Pub. No.: US 2007/0048475 A1
(43) Pub. Date: Mar. 1, 2007

(54) Refrigerant hose

(75) Inventor: Bradley James Haines, Sun Prairie, WI (US)

Correspondence Address: Roger D. Emerson, Esq.;BROUSE McDOWELL, Suite 500, 388 South Main Street, Akron, OH, 44311-4407, US

(73) Assignee: The Goodyear Tire & Rubber Company

(21) Appl. No.: 11/216,368

(22) Filed: Aug. 31, 2005

(51) Int. Cl. F16L 11/04

(52) U.S. Cl. 428/36.91

(57) ABSTRACT

A hose suitable for use in refrigerant systems, the hose includes an inner core layer or a barrier layer comprising a polyamide resin that includes polyamide 9T. Incorporation of polyamide 9T improves permeation resistance and flexibility of the hose over currently practiced methods.

### I. BACKGROUND OF THE INVENTION

A. Field of Invention

The disclosed invention relates to refrigerant hoses for use in automotive and industrial air conditioners.

B. Description of the Related Art

Hoses are used for transporting refrigerants in vehicle air conditioning systems, and in industrial and residential refrigerant systems. The hoses used in these systems generally have a multi-layer laminar construction that includes an inner layer, an outer cover layer located radially outwardly of the inner layer, and a reinforcing fiber layer interposed between the inner layer and the outer layer. Generally, the inner layer is formed of rubber, including butyl rubbers (IIR, CIIR, BIIR or BIMS), ethylene propylene diene rubber (EPDM), chloroprene rubber (CR), nitrile rubbers (NBR, HNBR), or ethylene acrylic copolymer rubber (AEM). The reinforcing fiber layer usually is a mesh structure formed by braided organic yarn such as polyester fiber, rayon fiber, or nylon fiber. The outer cover layer typically is formed of EPDM, CR, butyl rubbers, or AEM. Additionally, adhesion layers may be employed between the layers.

Hoses may be characterized as barrier or veneer hoses, the distinction between the two being the type of material forming the inner layer. Barrier hoses have the innermost layer formed of an elastomeric material and a barrier layer located outward of the innermost layer. In hoses where the barrier layer is the innermost layer, the hose is referred to a veneer hose. Some applications may use either type of hose, such as fuel hose, while other applications may require a specific internal material and thus only one type of hose would be appropriate.

The hoses discussed above, due to their rubber components, have a high degree of flexibility. Because of this, the rubber hoses can be handled with ease. However, rubber materials generally tend to have high gas permeability, which is undesirable. Attempts to improve the resistance of conventional rubber hoses to refrigerant permeation have been made by incorporating polyamide layers, such as nylon 6, nylon 66, modified nylon 6, or alloys of nylon 6, etc, as an inner layer. Such efforts at incorporating polyamide layers and layers of polyamide blends into refrigerant hoses have previously been described in a number of references including U.S. patent application Ser. Nos. 10/886,883, 10/733,147, 10/230,035, and 10/142,098, and U.S. Pat. No. 4,633,912, each of which is incorporated herein.

The incorporation of polyamide layers, while reducing permeation rates, also reduces the flexibility of the hoses. To achieve an acceptable compromise of the required characteristics, the thickness of a nylon inner core layer is conventionally at least 0.5 mm (0.02″); see also U.S. Pat. No. 4,633,912, which discloses a polyamide blend cores tube with a gauge thickness of 1.07 mm and 0.81 mm. Plasticizers may also be incorporated to assist in improving the flexibility of hoses. While the hoses described in the above identified and incorporated patent applications are suitable for their intended purpose, it remains desirable to include in refrigerant hoses, materials that further enhance the impermeability of the hose while maintaining flexibility. The present invention addresses this through the inclusion of polyamide 9T in refrigerant hoses as a replacement for, or in a blend with, one or more of polyamide 6 and modified versions of polyamide 6, where suitable, such as in the inner layer. Polyamide 9T offers improved heat resistance, lower permeation, and improved abrasion assistance with no reduction in flexibility. In certain applications, this is an improvement over existing designs.

### II. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a perspective view of one embodiment of the hose in accordance with the present invention, wherein the hose includes a polyamide resin or polyamide resin blend as the material for the inner layer.

FIG. 2 is a cross sectional view of a second embodiment of the hose in accordance with the present invention, wherein the hose, which may be a barrier hose, includes a polyamide resin or polyamide resin blend as the material for at least a portion of the barrier layer.

FIG. 3 is a cross sectional view of a third embodiment of the hose in accordance with the present invention, wherein the hose includes a polyamide resin or polyamide resin blend as the material for at least a portion of the barrier layer and wherein the barrier layer includes at least three sub-layers.

FIG. 4 is a cross sectional view of a fourth embodiment of the hose in accordance with the present invention, wherein the hose includes a polyamide resin or polyamide resin blend as the material for at least a portion of the barrier layer, and wherein the hose is a veneer hose.

### III. DESCRIPTION OF THE PREFERRED EMBODIMENT

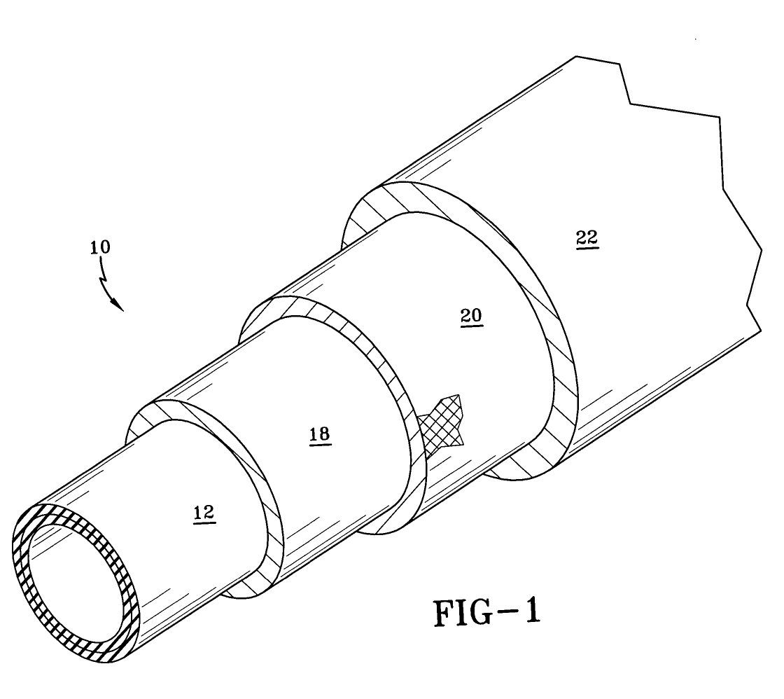

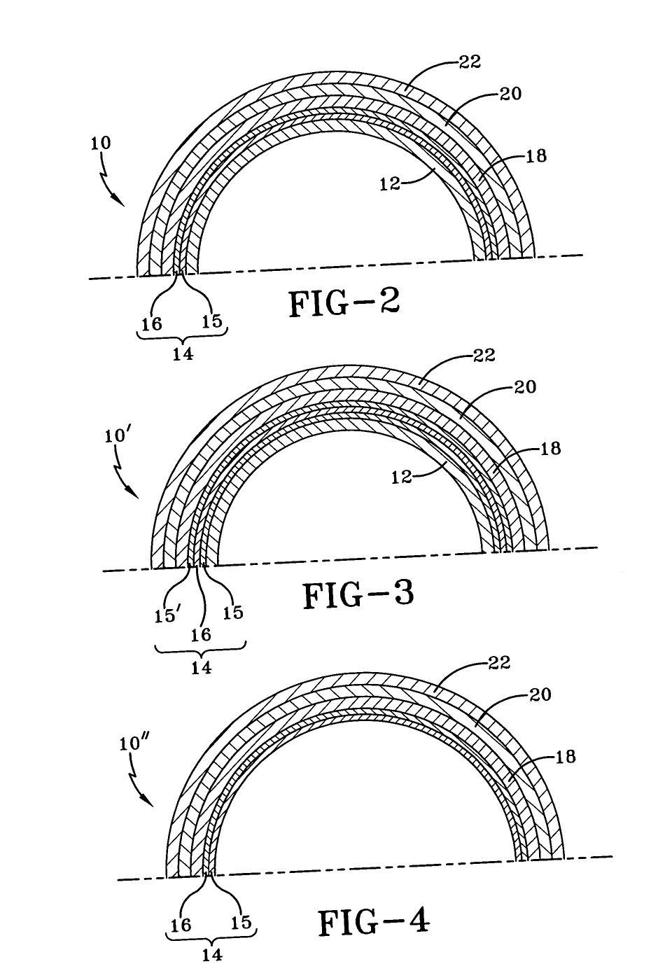

One embodiment of the refrigerant hose 10 of the present invention is illustrated in FIG. 1. As shown in FIG. 1, the hose 10 has an inner or core layer 12, relative to the radial direction of the hose and the longitudinal hose axis. Over the core layer 12 there may be an elastomeric friction layer 18, over which there may be a reinforcing layer 20, and overall, an outer or cover layer 22. In an alternate embodiment, illustrated in FIG. 2, which is an embodiment of a barrier hose, there may be a barrier layer 14, located between the core layer 12 and the elastomeric friction layer 18. The barrier layer 14 may itself include multiple sub-layers 15, 16.

Referring now to the embodiment shown in FIG. 1, the core layer 12 may be formed substantially of the single polyamide resin, polyamide 9T (hereafter “PA9T”) or a blend a polyamides which includes PA9T. To achieve a low permeation of the completed hose, when using a polyamide resin, or a blend of polyamide resins, the polyamide is preferably non-plasticized. The addition of a plasticizer to the polyamide improves the flexibility of the material; however, it also decreases the permeability characteristics of the nylon. Thus, non-plasticized polyamide are preferred in all embodiments described herein.

As noted above, suitable polyamides for use in the core layer 12 include PA9T and blends of PA9T with one or more of nylon 6 or copolymers of nylon 6 and nylon 66. In one embodiment, the core layer 12 consists essentially of PA9T. In another embodiment, the core layer 12 may comprise a blend of PA9T and nylon 6. In yet another embodiment, the core layer 12 may comprise a blend of PA9T and a copolymer of nylon 6 and nylon 66. In still other embodiments, PA9T may be blended with one or more of nylon 46, nylon 11, nylon 12, nylon 610, nylon 612, nylon 6/66/610 copolymer, nylon MXD6, nylon 6T, nylon 6/6T copolymer, nylon 66/PP copolymer, and nylon 66/PPS copolymer to form the material for the core layer 12. Suitable PA9T, the composition and structure of which are taught more fully in U.S. Pat. No. 5,670,608, is available from Kuraray. Suitable nylon 6 is available from DuPont. Suitable copolymer of nylon 6 and nylon 66 is available from Atofina.

Where polyamide blends are used, the polyamides may be blended using any of the thermoplastic blending methods as are known in the art, including but not limited to extrusion. The core layer 12 may be extruded from preblended polyamides, or formed directly by extrusion of a mixture of polyamide pellets.

With continued reference to the embodiment illustrated in FIG. 1, layer 18 may be an elastomeric friction layer between the core layer 12 and the reinforcing layer 20 and provides flexibility to the hose 10. The elastomer selected for this layer should meet those characteristics. For adhesion to the adjacent polyamide core layer 12, the elastomeric layer 18 may be extruded onto the core layer 12. The layer may also be applied in the form of a sheet either spirally wrapped or butt seamed. These methods of applying such layers are known in the art, and variations thereof are contemplated herein.

With continued reference to FIG. 1, the elastomeric friction layer 18 may comprise a base polymer selected from polyisoprene, polybutadiene, copolymers of butadiene and acrylonitrile, copolymers of butadiene and styrene, butyl-rubbers, chloroprene rubber, nitrile rubbers, polybutadiene, ethylene propylene copolymers, EPDM, ethylene propylene norbornene terpolymers, ethylene propylene-1,4-hexadiene terpolymers, ethylene propylene dicyclopentadiene terpolymers, and blends of the aforementioned polymers. In one embodiment, the base stock for the friction layer is EPDM.

Continuing with respect to the embodiment illustrated in FIG. 1, the base polymer in the elastic friction layer 18 may further comprise an adhesive system and a peroxide or sulfur curative. The adhesive systems useful are the conventionally known resorcinol, phenolic, or maleinized polybutadiene based adhesive systems. The resorcinol component may be added to the elastomer in the nonproductive mix, or preformed adhesive resins may be added during the productive mix. The amount of adhesive system utilized in the elastomeric friction layer 18 can range from 1 to 10 parts by weight based on 100 parts of base stock polymer. The peroxide or sulfur curatives useful in the friction layer 18 are those that are normally used in such base stocks. The peroxide or sulfur curatives useful in the elastomeric friction layer are those that are normally used in such base stocks. For example peroxides such as dicumyl peroxide, [.alpha.,.alpha.′-bis(t-butylperoxide)diisopropylbenzene], benzoyl peroxide, 2,4-dichlorobenzoyl peroxide, 1,1-bis(t-butylperoxy)3,3,5-trime-thylcyclohexane, 2,5-dimethyl-2,5-bis(t-butylperoxy)hexane, 2,5-dimethyl-2,5-bis(t-butylperoxy)hexyne-3, and n-butyl 4,4-bis(t-butylperoxy)valerate. From 1 to about 10 parts of peroxide or sulfur are utilized based on 100 parts of base polymer.

The reinforcing layer 20 may be a fiber layer as commonly used as a reinforcing layer for hoses. The reinforcing layer 20 may be formed by braiding, spiraling, knitting, or helical knitting of yarn. The yarn may be selected from conventional hose reinforcing yarns such as glass, steel, cotton, polyester, or aramid fibers, or a blend of any of these fibers.

A base polymer for the cover layer 22 may be selected from known cover layer polymers and blends thereof, including but not limited to nitrile-butadiene rubber (NBR), chlorosulfonated polyethylene rubber (CSM), ethylene-propylene-diene rubber (EPDM), butyl rubber (IIR), chlorinated butyl rubber (Cl-IIR), brominated butyl rubber (Br-IIR), epichlorohydrine rubber (CHR, CHC), acrylic rubber (ACM), chloroprene rubber (CR), ethylene-acrylic elastomer (AEM) and the like. In one embodiment, the base stock for the cover layer is AEM.

As discussed above, the hose 10 having and inner core 12 that includes PA9T, such as is illustrated in FIG. 1, may have a low permeation rate with refrigerants. The hose 10 may have a permeation rate of less than 0.210 g/m/day. A hose with a permeation rate of less than 0.5 is considered an ultra low permeation hose.

In an alternate embodiment of the hose 10, shown in FIG. 2, there may be a barrier layer 14 located between the core layer 12 and the elastomeric friction layer 18 of the hose 10. The barrier layer 14, may include multiple sub-layers 15, 16. For purposes of illustration, but not limitation, two sub-layers are depicted in FIG. 2; a first barrier layer 15 and a second barrier layer 16.

In accordance with the alternate embodiment illustrated in FIG. 2, the core layer 12 may be formed from an elastomeric material. As this core layer 12 is adjacent to the barrier layer 14, it should preferably be able to bond to the barrier layer 14. Such materials suitable for use in the core layer 12 in this embodiment include, but are not limited to chloroprene rubbers, nitrile rubbers, ethylene-propylene rubber, ethylene propylene diene rubber (EPDM), butyl rubbers (IIR, CIIR, BIIR), chlorosulfonated polyethylene rubber (CSM), ethylene-acrylic rubber (AEM), chlorinated polyethylene rubber (CPE), or brominated isobutylene-paramethylstyrene (BIMS). The core layer 12 may also be formed from thermoplastic elastomers or thermoplastic vulcanizates such as polyproplene, polyethylene, or other polyolefins blended with EPDM, IIR, NBR, or acrylic rubber.

With continued reference to FIG. 2, the barrier layer 14 may include a first barrier layer 15, which may be a thermoplastic layer, the material of which has a low permeation rate. Suitable low permeability materials include polyolefin thermoplastic resins, such as high density polyethylene (HDPE), ultrahigh molecular weight polyethylene (UHMWPE), polypropylene (PP), and ethylene propylene copolymer thermoplastic resin; and polyamide thermoplastic resins such as PA9T and polyamide blends of PA9T with one or more of nylon 6, nylon 66, nylon 46, nylon 11, nylon 12, nylon 610, nylon 612, nylon 6/66 copolymer, nylon 6/66/610 copolymer, nylon MXD6, nylon 6T, nylon 6/6T copolymer, nylon 66/PP copolymer, and nylon 66/PPS copolymer. As discussed above, to achieve a low permeation of the completed hose, when using a polyamide resin, or a blend of polyamide resins, the polyamide is preferably non-plasticized.

With continued reference to FIG. 2, the barrier layer 14 may, but need not include, a second barrier layer 16, which may constructed of a low permeability material differing from the first barrier layer 15. The material for the second barrier layer 16 may be a vinyl resin such as vinyl acetate (EVA), polyvinylalcohol (PVA), vinyl alcohol/ethylene copolymer (EVOH), polyvinylidene chloride (PVDC), polyvinyl chloride (PVC), vinyl chloride/vinylidene chloride copolymer, and vinylidene chloride/methylacrylate copolymer.

In constructing the barrier layer 14, the first barrier layer 15 may be the radially innermost layer, as shown in FIG. 2. However, the second barrier layer 16 may alternatively be the radially innermost layer. To maintain the required flexibility of the hose 10, each of the first and second barrier layers 15, 16, may have a radial thickness of between 0.001 to 0.010 in (0.025-0.254 mm). A preferred thickness for each of the first and second barrier layers 15, 16 is 0.001 to 0.005 in (0.025-0.127 mm). As noted, the barrier layer 14 may only include the first barrier layer 15.

With continued reference to the second embodiment of the hose 10 depicted in FIG. 2, the elastomeric friction layer 18, which is directly adjacent to barrier layer 14, should preferably be able to bond to the barrier layer 14. The elastomeric friction layer 18 may be formed of the same elastomeric materials suitable for the inner core layer 12.

The reinforcing layer 20 may be formed by braiding, spiraling, knitting, or helical knitting of yarn. The yarn may be selected from conventional hose reinforcing yarns such as glass, steel, cotton, polyester, or aramid fibers, or a blend of any of these fibers.

The material for the cover layer 22 may be selected from known hose cover layer materials, including but not limited to nitrile-butadiene rubber (NBR), chlorosulfonated polyethylene rubber (CSM), EPDM, butyl rubbers, chlorinated butyl rubber (Cl-IIR), brominated butyl rubber (Br-IIR), epichlorohydrine rubber, acrylic rubber (AEM), chloroprene rubber (CR), BIMS, and the like. For purposes of this embodiment, the cover may be formed from thermoplastic elastomers or thermoplastic vulcanizates, similar to the materials in the core layer 12.

The present invention achieves a very low, permeation rate without the use of a metallic foil or layer within the hose, while incorporating the improvements obtained by the use of PA9T in place of part or all of the material for the barrier layer 14.

A third embodiment of the present invention is illustrated in FIG. 3. The hose 10′ has an inner or core layer 12, a barrier layer 14, an adjacent elastomeric friction layer 18, a reinforcing layer 20, and a cover layer 22. In this embodiment, the barrier layer 14 of the hose 10′ may have at least three layers, 15, 16, 15′. The layer identified as 15′ may be known as the third barrier layer, which, in combination with the first barrier layer 15 and second barrier layer 16, may form the barrier layer 14. The material selected for the first barrier layer 15, which may be the radially innermost layer may be repeated as the material for the third barrier layer 15′, which may by the radially outermost layer and may be selected from the materials identified for use in the first barrier layer 15 of the embodiment shown in FIG. 2 and discussed above. Preferably, the middle layer 16 is formed of the material having the lowest permeation rate, such as is described with respect to the hose 10 illustrated in FIG. 2 and more specifically, the materials of the second barrier layer 16 discussed therein.

A fourth embodiment of the present invention is illustrated in FIG. 4. In this embodiment, the hose 10″ has no innermost elastomeric layer 12. Instead, the barrier layer 14 forms the innermost layer and the hose 10″ is a veneer hose. In the illustrated embodiment, the barrier layer 14 is formed of two barrier layers 15, 16 formed of the materials, and in the manner, discussed above with respect to the embodiments illustrated in FIGS. 2 and 3. Similar to the second embodiment, the veneer hose 10″ may also have the barrier layer 14 formed of three layers wherein the first and third barrier layers 15, 15′ sandwich the second barrier layer 16.

The intended use of the hose, including the intended fluid or gas that will flow through the hose, will determine which of the various disclosed barrier or veneer hose constructions is appropriate.

With reference to FIGS. 2-4, construction of the hose 10 is accomplished in the following manner.

The innermost layer 12 may be extruded onto either a flexible or fixed mandrel. The barrier layer 14 may be formed by co-extruding the different layers simultaneously onto the innermost layer 12. A multi-layer head may be used for the extrusion. When the barrier layer 14 is formed as a three-layer element, such as is depicted in FIG. 3, a tri-extrusion head may be used. When forming the barrier layer 14 as a two layer element, as depicted in FIGS. 2 and 3, a dual extrusion head or a tri-extrusion, with one silent port, may be used. No adhesive need be applied between the different barrier layers 15, 15′, 16 as the bonding between the layers may be accomplished through melt bonding.

After the barrier layer 14 is formed, either another elastomeric layer 18 may be applied or the reinforcement layer 20 may be immediately applied. The cover layer 22 may be applied last. The formed hose length may then be vulcanized to cure the elastomeric layers. The hose length may be cut into definitive lengths either before or after curing. If the hose length is cut prior to curing, then typically, the hose lengths are cured on fixed curve short length mandrels designed to impart a fixed and final configuration to the hose.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

Having thus described the invention, it is now claimed:

I/We claim:

1. A hose comprising:
a core layer,
an elastomeric friction layer overlaying the core layer,
at least one reinforcement layer overlaying the friction layer,
and a cover layer overlaying the at least one reinforcement layer,
wherein the core layer is comprised of a first polyamide resin; and
wherein the first polyamide resin is polyamide 9T.

2. The hose of claim 1, wherein the core layer further includes a second polyamide resin; and
wherein the second polyamide resin is selected from the group consisting of nylon 6, nylon 6/66 copolymer, nylon 46, nylon 11, nylon 12, nylon 610, nylon 612, nylon 6/66/610 copolymer, nylon MXD6, nylon 6T, nylon 6/6T copolymer, nylon 66/PP copolymer, and nylon 66/PPS.

3. The hose of claim 2, wherein the first and second polyamide resins are blended.

4. The hose of claim 1 wherein the elastomeric friction layer comprises a base polymer selected from the group consisting of EPDM, butyl rubbers, nitrile rubbers, and chloroprene rubbers, and blends thereof.

5. The hose of claim 1 wherein the cover layer comprises a base polymer selected from the group consisting of AEM, butyl rubbers, EPDM, nitrile rubbers, and chloroprene rubbers, and blends thereof.

6. A hose in accordance with claim 1 wherein the hose has a permeation rate of less than 0.5 g/m/day.

7. A hose in accordance with claim 6 wherein the hose has a permeation rate of less than 250 g/m/day.

8. A hose comprising:
a barrier layer,
at least one reinforcement layer overlaying the barrier layer,
and a cover layer overlaying the at least one reinforcement layer,
wherein the barrier layer is comprised of a first polyamide resin; and
wherein the first polyamide resin is polyamide 9T.

9. The hose of claim 8, further comprising:
A core layer located radially inwardly of the barrier layer, the core layer comprised of an elastomeric material.

10. The hose of claim 9, wherein the barrier layer further includes a second polyamide resin; and
wherein the second polyamide resin is selected from the group consisting of nylon 6, nylon 6/66 copolymer, nylon 46, nylon 11, nylon 12, nylon 610, nylon 612, nylon 6/66/610 copolymer, nylon MXD6, nylon 6T, nylon 6/6T copolymer, nylon 66/PP copolymer, and nylon 66/PPS.

11. The hose of claim 10, wherein the first and second polyamide resins are blended.

12. The hose of claim 8, wherein the barrier layer includes:
a first barrier layer comprised of polyamide 9T; and
a second barrier layer radially adjacent the first barrier layer, the material of the second barrier layer comprising a vinyl resin.

13. The hose of claim 12, wherein the first barrier layer further includes a second polyamide resin; and
wherein the second polyamide resin is selected from the group consisting of nylon 6, nylon 6/66 copolymer, nylon 46, nylon 11, nylon 12, nylon 610, nylon 612, nylon 6/66/610 copolymer, nylon MXD6, nylon 6T, nylon 6/6T copolymer, nylon 66/PP copolymer, and nylon 66/PPS.

14. The hose of claim 12, wherein the barrier layer further includes:
a third barrier layer.

15. The hose of claim 14, wherein the first barrier layer is located radially inward of the second barrier layer and the second barrier layer is located radially inward the third barrier layer; and
wherein the third barrier layer is comprised of polyamide 9T.

16. The hose of claim 15, wherein at least one of the first and third barrier layers further includes a second polyamide resin; and
wherein the second polyamide resin is selected from the group consisting of nylon 6, nylon 6/66 copolymer, nylon 46, nylon 11, nylon 12, nylon 610, nylon 612, nylon 6/66/610 copolymer, nylon MXD6, nylon 6T, nylon 6/6T copolymer, nylon 66/PP copolymer, and nylon 66/PPS.

17. The hose of claim 16, wherein the first and second polyamide resins are blended.
